(19) United States
(12) Patent Application Publication
(10) Pub. No.: US 2026/0212324 A1
(43) Pub. Date: Jul. 23, 2026

(54) CRM System Implementing Appointment Generation Based on Customer Profiles

(71) Applicant: Webinarin, LLC, Boca Raton, FL (US)

(72) Inventor: Kyle Disher, Boca Raton, FL (US)

(21) Appl. No.: 19/455,795

(22) Filed: Jan. 21, 2026

Related U.S. Application Data
(60) Provisional application No. 63/747,868, filed on Jan. 21, 2025.

(51) Int. Cl. G06Q 10/1093; G06Q 30/01

(52) U.S. Cl. CPC G06Q 10/1093; G06Q 30/01

(57) ABSTRACT

New systems, devices and methods for creating and managing business appointments are provided. In some embodiments, a customer relationship management system (“CRM” system) is provided, including a control system comprising specialized computer hardware and software, which manages a wide variety of communications and communications types between a business and its customer or a “lead,” meaning a person or entity with an indicated or potential interest in becoming a customer of the business, who or which is not yet a customer. In some such embodiments, such a CRM system determines when one or more business appointment “triggers” has occurred during such communications, which triggers may be variably defined by a user and/or the system, in various embodiments, and generates a business appointment proposal based on particular information determined to be present within the communications.

### CROSS-REFERENCE TO RELATED APPLICATIONS

This application claims the benefit of priority to U.S. Provisional Application No. 63/747,868, filed Jan. 21, 2025, titled “System for Improving Sales Lead Development through Appointment Creation and Management,” the entire contents of which is herein incorporated by reference in its entirety.

### FIELD OF THE INVENTION

The present application relates to the field of systems for creating and hosting business appointments via specialized computer hardware and software. The present invention also relates to systems, devices and methods for project management.

### BACKGROUND

Interpersonal meetings to conduct business predate recorded history, which started in the ancient civilizations of Sumer and Egypt at least 3,000 BCE. Early humans, in hunter-gatherer societies, and even wild animals, engage in meetings to exchange things of value. For example, crows are known to bring items to humans in exchange for food, and chimpanzees provide food to each other in exchange for social rewards. While many of these early business meetings can be thought of as chance encounters, scheduled routines were sometimes created. For example, agricultural production increases at particular times of year, and early civilizations began to develop calendars to plan the business around agricultural harvests.

Egyptians are credited with developing the first widely used annual calendar, based on the relative position of the sun and earth, which was already understood to follow a 365-day cycle. Dates were set on the annual calendar for recurring religious observances, regular weather occurrences (e.g., seasonal rains) and agricultural trade. The advent of the individual business appointment, meaning a pre-scheduled date and time at which two business counterparties would negotiate and consummate business deals, became more prevalent in the second millennium CE. As industrialization took root, business schedules became tighter, requiring careful planning to avoid missed appointments and wasted time, generally.

Business appointment calendaring systems have been in widespread use since the 1800's. Business counterparties typically propose appointment times and dates and, once an agreement is reached, record the planned future time and date of the business appointment. Modern calendaring and appointment systems, using computer hardware and software applications (“Apps”) may even generate reminders, at pre-set intervals, prior to an appointment time and date, to aid the counterparties (a.k.a. “participants” or “attendees” in the business meeting subject to the appointment) in remembering to attend the business meeting. Some App-based appointment systems may generate “invites,” meaning an electronic message inviting one or more participants to the business appointment. Although many business appointments are still carried out in-person, or over the phone, these invites may include links to virtual meeting network addresses, for example, using video conferencing software, such as the videoconferencing Apps. ZOOM, GOOGLE MEET and WEBEX are among the most popular software-based options available over the Internet, and run at about 30 FPS. Lag has remained a persistent problem raised frequently by users of videoconferencing Apps. Some Apps include texting (a.k.a. “chat”) features, and virtual whiteboards, allowing multiple team members on a project to collaborate on written work in real time, as well as oral conversations. Recently, the popularity of these modern platforms has increased, albeit, perhaps, temporarily, with the onset of the Covid-19 global pandemic beginning in 2019, which placed a premium on collaboration between people at a safe distance.

However, even in modern appointment calendaring systems, business appointments are still often missed by the participants. Despite teleconferencing options, electronically generated reminders and invitations (a.k.a. “invites”), however frequent, may be missed if the participants happen not to be attending to their computerized device receiving the invite or reminder at the time the reminder or invite is generated. And, even when so attending to their computerized device, numerous other distractions (e.g., from other Apps) may distract the participants. Other business events, aside from the business appointment subject to a reminder or invite, can be urgent, unpredictable and distracting, and may interfere with that appointment.

There remains a long-felt need for better business appointment systems, devices and methods.

It should be noted that some of the disclosures set forth as background, such as, but not limited to, the above language under the heading “Background,” do not relate to prior art and the state of the art in the field(s) of the invention, and should not be construed as an admission with respect thereto.

### SUMMARY OF THE INVENTION

New systems, devices and methods for creating and managing business appointments are provided. In some embodiments, a customer relationship management system (“CRM” system) is provided, including a control system comprising specialized computer hardware and software, which manages a wide variety of communications and communications types between a business and its customer or a “lead,” meaning a person or entity with an indicated or potential interest in becoming a customer of the business, who or which is not yet a customer. In some such embodiments, such a CRM system determines when one or more business appointment “triggers” has occurred during such communications, which triggers may be variably defined by a user and/or the system, in various embodiments, and generates a business appointment proposal based on particular information determined to be present within the communications.

For example, in some embodiments, the specialized computer hardware and software includes an e-mail analysis module, configured to analyze text in one or more text messages, e-mails or voice messages between an agent of the business and the customer or lead (“E-mail Analysis Module”). In some embodiments, the E-mail Analysis Module scans all text in each such message, and records it in a text file or other data storage location identifying the date and time that such a message was sent. And, in some embodiments, the E-mail Analysis Module then identifies potentially appointment-related key words and phrases within each such text file or other data storage location.

In some embodiments, such specialized computer hardware and software includes an artificial intelligence sub-module, such as a large language model (“LLM”) trained on a wide variety of business correspondence which, in the past, immediately has led to appointment invitations between such an agent of the business and its customers and leads. In some such embodiments, the LLM is configured to predict, based on the above-described text and sending dates of the above-discussed text file or other data storage location identifying the date and time that such a message was sent, the text and format of one or more appointment invitation(s) that should be sent, and to whom such an appointment should be sent (e.g., to one or both of the agent(s), customer(s) or lead(s)). However, in some embodiments, the LLM operates under the constraints with respect to the predicted appointment invitation(s) that: 1. a proposed appointment date and time cannot be in the past; 2. a proposed appointment date and time cannot be too far in the future, as may be variably set by an administrative user, in some embodiments, and/or 3. appointments must be made only between conversationally related parties.

The LLM then initiates a command, by the control system, to an appointment generation sub-module, which may generate one or more appointment invitation(s) to the identified, conversationally-related parties, in some embodiments.

However, in some embodiments, the appointment-generation sub-module does not immediately generate and/or send such an appointment invitation(s) if: 1. the identified, conversationally-related parties have already received a similar appointment invitation; and/or 2. the identified, conversationally-related parties have already accepted a similar appointment invitation.

An appointment invitation generated by the appointment-generation sub-module may include a wide variety of appointment-related text, which may be generated by the algorithm and/or LLM. For example, in various embodiments, such appointment-related text may include: A. a type of appointment (e.g., describing whether the proposed appointment relates to sales or servicing of a vehicle, in the context of an automotive dealership business using the CRM); B. the name(s) and contact information of the invitees; C. a calendar day proposed for such an appointment; D. a proposed duration of the proposed appointment; E. a proposed start time of the proposed appointment; F. a proposed meeting format (e.g., in-person, via teleconferencing, or video conferencing and if so, a conferencing link or telephone number); G. one or more key expectations or information beneficial for conducting the proposed appointment (such as the make and model of a motor vehicle, again, in the context of an automotive CRM, where the business in question is an automotive dealership, for example); and H. other agents of the business (such as service staff) that may attend or otherwise be relevant to the appointment.

In some embodiments, a follow-up sub-module of the control system is included, which determines whether an appointment subject to such an appointment invitation(s), has taken place (e.g., through a meeting tracking sub-module, or video meeting tracking cookie, in some embodiments). If not, in some such embodiments, the follow-up module re-runs the appointment generation submodule, and generates one or more additional appointment invitation(s) to the identified, conversationally-related parties, and so on, until a threshold number of unsuccessful appointment invitations have been generated for the next appointment between the agent(s), customer(s) or lead(s) subject to the unsuccessful appointment invitations. In some embodiments, the follow-up sub-module generates data related to one or more key performance indicators for a sales agent(s) of the business, or other party subject to the appointment invitation(s), for example, based on the number of unsuccessful appointment invitations generated for one or more meetings.

In some embodiments, the customer relationship management system (CRM) comprises a control system, comprising one or more processor(s) and software, verifying an identity of a user based on a multi-factor (e.g., 2-factor, or 3-factor) authentication challenge, and providing access to at least one specialized graphical user interface (GUI) to the user after the user has passed the authentication challenge, which may be at least partially administered on a peripheral device of the user, which may also contain another control system, and is communicatively connected with the control system of the CRM (e.g., via a network, such as a wireless network. Once the user's identity has been thus verified, in some such embodiments, a user may proceed to carry out, or direct that the CRM carry out, any of the steps for appointment generation and management set forth in this application, and/or vary one or more settings, for example, using another specialized graphical user interface (GUI), which settings are related to any of the constraints and thresholds set forth in this application.

For example, in some embodiments, an administrative user of the CRM system may variably set a threshold number of unsuccessful appointment invitations to be generated for a next appointment between the agent(s), customer(s) or lead(s) subject to unsuccessful appointment invitations, as that threshold is discussed in this application. As another example, in some embodiments, an administrative user of the CRM system may variably set a number of appointment parameters as constraints, such as the length of time of an appointment proposed in an invitation, or an amount of time into the future from the date of one or more communications between the agent(s), customer(s) or lead(s), that a meeting may be proposed to be held within invitations, as a constraint. In some embodiments, a “calendar view” GUI component is included, which provides a view of all available dates and times for appointments, whether booked or open, for one or more of such business appointment invitees. In some such embodiments, such a calendar view includes multiple open or booked, standardized appointment times—a.k.a., “time blocks.” In some such embodiments, the duration of such time blocks may be variably set (e.g., to 15 or 30-minute intervals), for example, by an administrative user of the CRM system. In some embodiments, multiple different calendar views may be available, for example, to administrative users, whose identity may be separately, but similarly, verified as discussed for other user(s), above, to view the open and booked time blocks for different invited parties. For example, in some embodiments such an administrative user is a sales manager, and the multiple different calendar views may each represent a different sales representatives managed by the sales manager. Such a GUI may include lead tracking tools, identifying a list of leads generated by marketing efforts for the business. The GUI may display statuses for each of such leads, based, at least in part, on the status of invitations and appointments, discussed in this application. For example, if a lead has not successfully attended a business appointment subject to such an invitation when scheduled, it may be shown within a “missed” tool and area of the GUI. For example, if a lead has not successfully attended a business appointment subject to such an invitation when scheduled, it may be shown within a “missed leads” tool and area of the GUI. As another example, in some embodiments, if an appointment invitation has not been sent out to a lead, the lead may be shown within an “unappointed leads” tool and area of the GUI. And, as yet another example, if an appointment invitation has been sent out to a lead, and such an invitation has been accepted, the lead may be shown within an “scheduled leads” tool and area of the GUI. In some embodiments, the GUI may include an assignment sub-tool, with respect to a lead indicator tool for each lead, showing an agent of the business assigned to the lead (and the administrative user may reassign such leads to different agents, in some embodiments, using such an assignment sub-tool of the GUI).

In some embodiments, lists of appointments may be received and uploaded, and/or generated by the CRM system, by agent and calendar. For example, in some embodiments, the CRM system may generate a list of business appointments, their status, and other text and information from invitations and notes related to the business appointments, for example, in the form of a .csv or EXCEL file. Conversely, in some embodiments, the CRM system may accept and upload such a list of business appointments, their status, and other text and information from invitations and notes related to the business appointments.

In some embodiments, the CRM system is configured to be integrated with a wide variety of auxiliary or additional communications and calendaring systems. For example, in some embodiments, the CRM system is integrated (e.g., via API or webhook) with a system by VINSOLUTIONS, such as an appointment management system thereof. And, in some embodiments, the CRM system is integrated with commonly-used calendaring software, such as GOOGLE CALENDAR or OUTLOOK CALENDAR. In some such embodiments, information between the CRM system and such an auxiliary or additional communications and calendaring system may be synced (e.g., in real time) via an ongoing, live network and/or API connection(s). In some embodiments, leads identified by the auxiliary or additional communications and calendaring systems may be tracked by the CRM system, and statuses of such leads may be updated within the auxiliary or additional communications and calendaring systems, based on the status of the appointment invitations. For example, where a first appointment invitation has been sent to a sales lead, the sales lead may be labeled “new” through an API interface with VINSOLUTIONS. As another example, where an appointment invitation to a lead has not been accepted or carried out for a threshold amount of time, and the follow-up submodule has been activated, the lead may be labeled as “follow-up” needed. And, as another example, where an appointment has been determined to have taken place, following a business appointment invitation, the lead may be labeled “contacted.” The CRM system may also issue reminders and status updates through such integrations, e.g., at user-variable intervals. For example, missed leads may trigger a missed-lead alert to users, in some embodiments.

In some embodiments, the CRM system includes an appointment generation subsystem which triggers the generation of invites and booked appointments through such auxiliary or additional communications and calendaring systems, through such an API or Webhook, and/or, in some embodiments, through an appointment booking message or invite generated and communicated by the appointment generation system through more conventional messaging channels (e.g., e-mail, SMS messaging) which are then sent to the lead. In some embodiments, the invite is sent as part of an appointment-triggering communications packet, which may also include urgency indicators, appointment-booking code (e.g., coded commands read and interpreted by a recipient user's peripheral device comprising a control system) and/or metadata. And, in some such embodiments, the contents and structure of such an appointment-triggering communications packet are based on a customer profile determined by a customer profile assessment artificial intelligence subsystem of the CRM system. In some embodiments, the customer profile assessment artificial intelligence subsystem determines a communications and/or business platform of the lead (e.g., using the lead's IP address, e-mail address, and location indicators) as part of a customer profile built to aid in closing and servicing the lead. And, in some embodiments, the customer profile assessment artificial intelligence subsystem determines a number of other technologies being used by the lead (i.e., a “Tech Stack”) as part of such a customer profile built to aid in closing and servicing the lead. In some embodiments, the customer profile assessment artificial intelligence subsystem determines one or more marketing demographic characteristic of the lead (e.g., the lead's geographic location) as part of such a customer profile built to aid in closing and servicing the lead. In some embodiments, appointment-triggering communications packet includes text, language, metadata, indicators and/or code which has a high probability of triggering an appointment generation aspect of the lead's Tech Stack, such as language indicating that an appointment has been, or will be, booked for a particular date, and particular time, duration and telephonic, video, augmented reality or virtual reality platform, among other triggering aspects. In some embodiments, a specialized artificial intelligence subsystem of the LLM is included within the appointment generation subsystem, which is trained based on whether a lead is successfully booked through such a packet for each Tech Stack, and other aspect of a customer profile. In some embodiments, text, language, metadata, indicators and/or code is varied (e.g., stochastically) for each possible Tech Stack encountered for each of a plurality of leads by the artificial intelligence subsystem of the LLM, and the artificial intelligence subsystem of the LLM is trained to improve a neural network of the LLM based on an outcome automatically labelled as positive when an appointment is successfully generated and held at the appointed time. In some embodiments, training of the neural network is through reinforcement learning, in which a successfully booked appointment is labeled as a positive outcome.

In some embodiments, before triggering the generation of invites and booked appointments, the appointment generation subsystem first obtains specific authorization from a lead to 1. record communications (e.g., live communications); 2. connect an AI agent component of the appointment generation subsystem; and 3. generate and/or trigger appointments and invites through the lead's communications and/or business platform. And, in some such embodiments, such an appointment booking, invite and/or appointment-triggering communications packet is only generated for the lead if such authorization is affirmatively provided. And, in some embodiments, an appointment confirmation may be issued to the lead by the appointment generation subsystem, which may include an appointment declination sub-tool, in some embodiments.

In some embodiments, the CRM system may be known as CALENGROW.

### Canons of Construction

Where any term is set forth in a sentence, clause or statement (“statement”) in this application, each possible meaning, significance and/or sense of any term used in this application should be read as if separately, conjunctively and/or alternatively set forth in additional statement(s), after the sentence, clause or statement, as necessary to exhaust the possible meanings of each such term and each such statement.

It should also be understood that, for convenience and readability, this application may set forth particular pronouns and other linguistic qualifiers of various specific gender and number, but, where this occurs, all other logically possible gender and number alternatives should also be read in as both conjunctive and alternative statements, as if equally, separately set forth therein.

The embodiments set forth in detail in this application are to ease the reader's understanding of inventions set forth herein and, as such, are only examples of the virtually innumerable number of alternative embodiments falling within the scope of the application. No specific embodiment set forth in this application should be read as limiting the scope of any claimed inventions.

These and other aspects of the invention will be made clearer below, in other parts of this application. This Summary, the Abstract, and other parts of the application, are for ease of understanding only, and no part of this application should be read to limit the scope of the invention, whether or not it references matter in any other part.

### BRIEF DESCRIPTION OF THE DRAWINGS

FIG. 1 depicts an example administrative dashboard GUI, including some example GUI tools, configured for use by an administrative user of a CRM system, in accordance with some embodiments of the present application.

FIG. 2 depicts some additional example GUI tools, which also may be utilized by an administrative user of a CRM system, in accordance with some embodiments of the present application.

FIG. 3 is a schematic block diagram of some elements of a control system, including computer hardware and software, which may include, or be included in, any of the CRM systems set forth in the present application, in accordance with some example embodiments.

FIG. 4 is a process flow diagram, illustrating several example steps that may be carried out by a control system, such as the example control system set forth above, in reference to FIG. 3, comprised in, or comprising, a CRM system, in accordance with some additional embodiments.

FIG. 5 is also a process flow diagram, illustrating several example steps that may be carried out by a control system, such as the example control system set forth above, in reference to FIG. 3, comprised in, or comprising, an appointment generation subsystem of a CRM system, in accordance with some additional embodiments.

FIG. 6 depicts an additional example GUI including some additional example GUI tools, which also may be utilized by a sales agent user of a CRM system, in accordance with some embodiments of the present application.

FIG. 7 depicts an additional example GUI including some additional example GUI tools, which may be issued to and utilized by a sales lead user of a CRM system, in accordance with some embodiments of the present application.

### DETAILED DESCRIPTION OF THE INVENTION

The example embodiments of the invention presented herein are directed to new systems, devices and methods for creating and managing business appointments, which are now described herein. This description is not intended to limit the application of the example embodiments presented herein. In fact, after reading the following description, it will be apparent to one skilled in the relevant art(s) how to implement the following example embodiments in alternative embodiments.

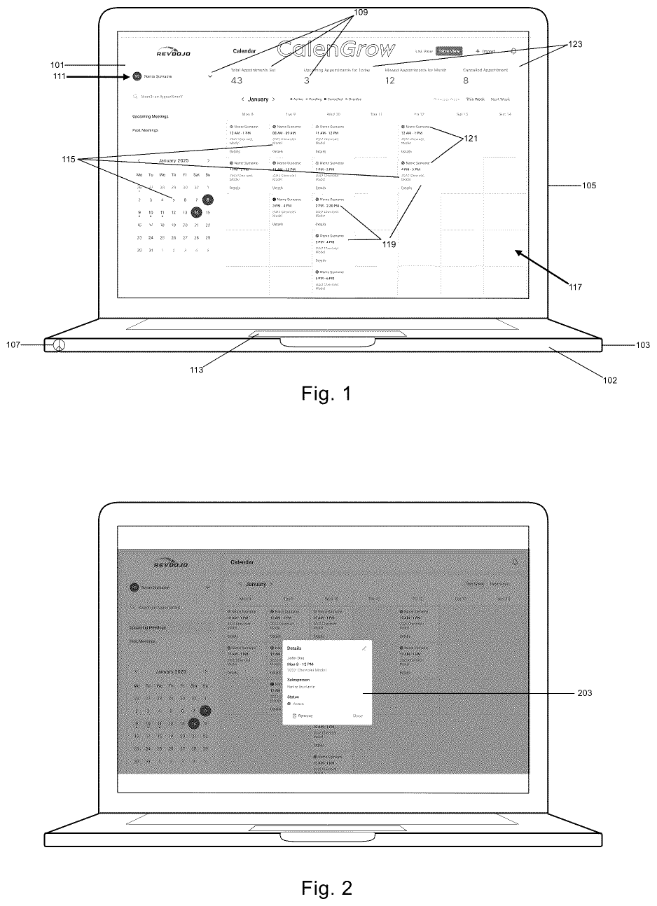

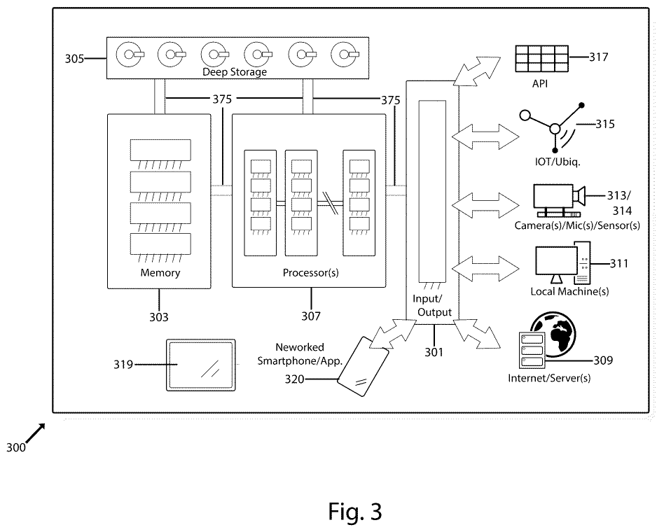

FIG. 1 depicts an example administrative dashboard GUI 101, including some example GUI tools, configured for use by an administrative user of a CRM system, in accordance with some embodiments of the present invention. As with any other GUI elements set forth in the present application, in some embodiments, GUI 101 may be may be presented and controlled by computer hardware and software of a control system, such as the example control system provided below, in reference to FIG. 3, which may comprise, and/or be comprised within, the CRM system, in some embodiments. In some embodiments, such a control system may include, or be included within, a computer 103, including local computer hardware, such as local display 105, and specialized software (e.g., a desktop software application, or “App”) which, when executed, causes some of the steps and processes set forth in this application to take place. But, if so, preferably, in some embodiments, computer 103 is connected for communications (e.g., to the Internet, via wireless communications antenna 107) and thus networked with another control system including computer hardware and software (e.g., a remote server), with additional specialized software (e.g., an SaaS web application) which, when executed, causes some of the steps and processes set forth in this application to take place. In some embodiments, a smartphone or other peripheral device-based app is included, as a part of, or in communication with, a control system included in case 102. However, the example of a local computer 103, and the example format of a laptop computer as pictured, is only one example of the virtually unlimited alternative forms and numbers of local and network-accessible computers that may be used to carry out aspects of the inventions set forth in this application, as will be apparent to those of skill in the art. For example, in some embodiments, multiple such local computers are provided. As another example, no local computer is provided, and, instead, all GUI tools and processes may be carried out on a single computer, which may or may not be a part of a network, in some embodiments. As another example, the format of a local computer may instead be a peripheral device, such as a smartphone or other personal digital assistant device, in some embodiments. In any event, any such computer may relay instructions and other information and monitor user selections, data input, and other user behavior, through GUI tools, such as the example GUI tools set forth below, to aid in carrying out the processes and steps set forth in this application.

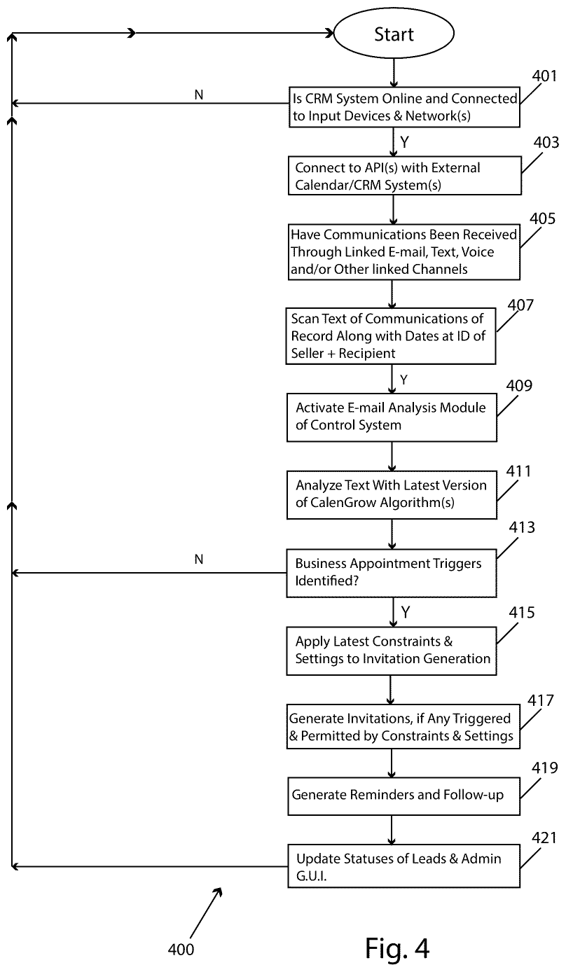

In some embodiments, and assuming the administrative user (not pictured but, e.g., a person using computer 103) has already created and logged in to its account, as set forth in step 401, discussed below in reference to FIG. 4, such GUI tools may be such as those shown as example GUI tools 109. Generally speaking, in the example pictured, GUI tools 109, and other GUI tools set forth in this application, aid an administrative user in the management of sales leads and business appointments held by agents of a business. However, as will be understood by those of ordinary skill in the art, in other embodiments, other business activities, modules, methods, and GUI tools adapted for them may be substituted. Thus, when, for convenience of illustration, the description below includes a statement having “sales” or “sales leads” as descriptive terms, it should be understood that, in alternative embodiments, the terms “business” and “business prospects,” may be substituted, respectively, as an additional statement, as if equally set forth herein.

For example, one such GUI tool is pictured as a calendar selection menu 111, which, when activated by a user (not pictured, but may be a human operator of computer 103) allow the user to navigate between alternative views of different business agents'calendars, each with their own, similar sets of GUI tools, other than those pictured in the present figure (e.g., presented on other “pages” created by html and other programming). For example, in some embodiments, the administrative user may select a drop-carrot 112 of calendar selection menu 111, to select from such alternative views. Similarly, the administrative user may “click on” any other available links, e.g., by using mouse 113 to place a pointer tool (not pictured) presented on display 105 over any of the example navigable links 115 and “clicking on” them, using mouse 111.

In some such embodiments, such an administrative user may vary one or more settings, for example, using a specialized GUI such as that pictured as GUI 101, which settings are related to any of the constraints and thresholds set forth in this application regarding business lead and appointment management. For example, in some embodiments, an administrative user of the CRM system may variably set a threshold number of unsuccessful appointment invitations to be generated for a next appointment between the agent(s), customer(s) or lead(s) subject to unsuccessful appointment invitations, as that threshold is discussed in this application. As another example, in some embodiments, an administrative user of the CRM system may variably set a number of appointment parameters as constraints, such as the length of time of an appointment proposed in an invitation, or an amount of time into the future from the date of one or more communications between the agent(s), customer(s) or lead(s), that a meeting may be proposed to be held within invitations, as a constraint.

In some embodiments, a “calendar view” GUI component 117 is included, which provides a view of all available dates and times for appointments, whether booked or open, for one or more of such business appointment invitees. In some such embodiments, such a calendar view GUI component includes multiple open or booked, standardized appointment times—a.k.a., “time blocks” 119. In some such embodiments, the duration of such time blocks may be variably set (e.g., to 15 or 30-minute intervals), for example, by an administrative user of the CRM system. In some embodiments, multiple different calendar views may be available, for example, to administrative users, to view the open and booked time blocks for different invited parties. For example, in some embodiments such an administrative user is a sales manager, and the multiple different calendar views may each represent a different sales representatives managed by the sales manager. Such a GUI may include lead tracking tools 121, identifying leads generated by marketing efforts for the business. The GUI may display statuses for each of such leads, based, at least in part, on the status of invitations and appointments, discussed in this application. For example, if a lead has not successfully attended a business appointment subject to such an invitation when scheduled, it may be shown within a “missed” tool and area of the GUI. For example, if a lead has not successfully attended a business appointment subject to such an invitation when scheduled, it may be shown within a “missed leads” tool and area of the GUI. As another example, in some embodiments, if an appointment invitation has not been sent out to a lead, the lead may be shown within an “unappointed leads” tool and area of the GUI. And, as yet another example, if an appointment invitation has been sent out to a lead, and such an invitation has been accepted, the lead may be shown within an “scheduled leads” tool and area of the GUI. In some embodiments, the GUI may include an assignment sub-tool, with respect to a lead indicator tool for each lead, showing an agent of the business assigned to the lead (and the administrative user may reassign such leads to different agents, in some embodiments, using such an assignment sub-tool of the GUI).

In some embodiments, GUI tools are provided that permit a user to view and explore statistical information (such as key performance indicators (“KPIs”) regarding efforts by other users to manage business prospects, such as sales leads. Example KPIs presentation tools 123 are provided, displaying various key information related to managing sales efforts by users using appointment invitation tools, are provided.

As will be apparent to those of ordinary skill in the art to which the present invention applies, a wide range of alternative GUIs and GUI tools may include, or be modified to include or combine with, the GUIs, aspects and techniques of the present invention, as set forth in this application, in some embodiments. The mention, depiction or discussion of any specific language, type or stylization of GUI tools and graphical features are only examples of the virtually unlimited alternatives falling within the scope of the invention.

More generally, the exact detailed embodiments provided throughout this application, including the aspects and techniques set forth in the figures and discussed in detail in this application are, of course, examples, and not limiting. Rather, these embodiments are intended only as a reasonable set of possible example systems, graphics, structures, substructures, GUIs, methods, steps, techniques and other aspects of the present invention, among virtually infinite and innumerable possibilities for carrying out the present invention, to ease comprehension of the disclosure, as will be readily apparent to those of ordinary skill in the art. For example, the description of one particular order, number or other arrangement of any aspects of the present invention set forth herein is illustrative, not limiting, and all other possible orders, numbers, arrangements, etc., are also within the scope of the invention, as will be so readily apparent. Any aspect of the invention set forth in this application may be included with any other aspect, as well as any aspects known in the art, in any number, order, arrangement, or alternative configuration, in particular embodiments, while still carrying out, and falling within the scope of, the invention.

FIG. 2 depicts some additional example GUI tools, on another example administrative dashboard GUI 201, which also may be utilized by an administrative user of a teleconferencing and relationship management system, in accordance with some embodiments of the present invention. As with the GUI tools set forth above, and other GUI tools set forth in the present application, the GUI tools of GUI 201 may be provided on a computer (which may comprise, or be comprised in, a control system, such as the example control system provided in FIG. 3, below), such as example computer 103, including local computer hardware, such as local display 105, and specialized software (e.g., a desktop software application, or “App”) which, when executed, causes some of the steps and processes set forth in this application to take place. But, if so, preferably, in some embodiments, such a computer is connected for communications (e.g., to the internet, via wireless communications antenna 107) and thus networked with another control system including computer hardware and software (e.g., a remote server), with additional specialized software (e.g., an SaaS web application) which, when executed, causes some of the steps and processes set forth in this application to take place. In some embodiments, as with other computers and control systems set forth in the present application, example computer 103, and such a control system of which it is a part, comprises and/or is comprised in a CRM system, as discussed in the present application. Such a CRM system, including such a control system comprised within or comprising it, are sometimes referred to, together, as a “the system,” throughout this application.

In some embodiments, GUI 201 includes a business appointment invitation GUI tool 203—namely, a pop-up panel resulting from the administrative user selecting (e.g., clicking on or double-clicking on, depending on the embodiment) a link or other previously appearing tool, in some embodiments. Generally speaking, GUI tool 203 aids a user in developing and servicing sales leads (which may be inbound and/or outbound sales leads from lists or other rank orders of such leads, generated by any techniques set forth in the present application) and creating a new grouping of sales leads for assignment to a business development or other non-administrative user (e.g., a sales representative) to complete in a certain manner, over a certain time period, which may be also managed, at least in part, by an business meeting invitation module and a follow-up module, in accordance with some embodiments. Accordingly, business appointment invitation GUI tool 203 includes a series of GUI sub-tools configured for that purpose, in some embodiments.

For example, a lead importation tool, such as example lead importation tool 205, is provided in some embodiments. By activating (again, e.g., “clicking on,” or double-clicking on, using a cursor or pointer GUI tool of the system) lead importation tool 205, the administrative user may upload a list (e.g., in comma-separated value, “csv,” or MICROSOFT EXCEL, “xls,” data file format) to the system of persons and/or entities which are a group of business prospects (e.g., sales leads), and information related to each such sales lead. In some embodiments, such a list may be generated from a lead pool. In some embodiments, the control system may rank such business prospects according to an urgency.

For example, in some embodiments, a sales lead management module of the teleconferencing and relationship management system ranks certain sales leads as more urgent and/or time-sensitive to engage (a.k.a. “hotter sales leads”) than other sales leads managed by the teleconferencing and relationship management system. In some embodiments, such a sales lead management module of the teleconferencing and relationship management system selects certain sales leads as the most urgent and/or time-sensitive to engage (a.k.a. “hot sales leads”) than other sales leads managed by the teleconferencing and relationship management system. In some such embodiments, the sales lead management module may create one or more lists, from a subset of business prospects identified in a lead pool, based on their similarity in such a ranking (e.g., based on each business prospect having such a ranking with a value within the same percentile of all rankings of business prospects in a lead pool, such as the top 5%, 10%, 20%, 30%, 40% or 50% of such rankings in the lead pool). In some embodiments, any of a: recency of contact, credit score, soft credit score, informal credit score, externally mined employment data (e.g., employment status, employment title, employer type, salary information, etc.), type of business experience or interest, and/or demographic information of the person or entity of a particular sales lead and/or business prospect, may positively or otherwise impact such an urgency rating for that prospect and/or generated script elements by an artificial intelligence module of the sales lead management module.

In some embodiments, a user assignment tool 207 is provided which, when activated by the administrative user, assigns such a group of sales leads to another user, for servicing through the teleconferencing and relationship management system.

In some embodiments, the administrative user may name a sales campaign being created and assigned to another user, by entering a title, or other terms for identifying such a campaign, for example, within a data entry window GUI sub-tool 209.

In some embodiments, the administrative user may create additional GUI sub-tools, for presentation within a GUI of the user handling such a campaign. For example, in some embodiments, as pictured, the administrative user may provide key data relevant to servicing sales leads within a campaign, such as a specialized sales script, to be provided to each such sales lead during a phone call, e-mail and/or text message sent to such a lead, using the teleconferencing and relationship management system. For that purpose, example script text uploading GUI tools 211, 213 and 215, respectively, are provided.

FIG. 3 is a schematic block diagram of some elements of a control system 300, including computer hardware and software, which may include, or be included in, any of the CRM systems set forth in the present application, in accordance with some example embodiments. In some example embodiments, the control system incorporates a non-transitory machine-readable medium storing instructions that, when executed by one or more processors, execute various aspects of the present inventions described in this application. The generic and other components and aspects described herein are not exhaustive of the many different systems and variations, including a number of possible hardware aspects that might be used, in accordance with the example embodiments of the invention. Rather, the control system 300 shown depicts some example embodiments.

Control system 300 includes an input/output device 301, a memory device 303, long-term data storage device 305, and processor(s) 307. The processor(s) 307 is (are) capable of receiving, interpreting, processing and manipulating signals and executing instructions for further processing and for output, pre-output and/or storage in and outside of the system. The processor(s) 307 may be general or multipurpose, single-or multi-threaded, and may have a single core or several processor cores, including microprocessors. Among other things, the processor(s) 307 is/are capable of processing signals and instructions for the input/output device 301, to cause a user interface to be provided or modified for use by a user on hardware, such as, but not limited to, computer system peripheral devices, such as a mouse, keyboard, touchscreen and/or other display 319, providing specialized tools (e.g., providing a graphical user interface, a.k.a. a “GUI,” providing any of the GUI tools as set forth in this application, e.g., for creating and managing business appointments and invitations, and managing and assigning sales leads and GUI sub-tools related to the same, as set forth in greater detail elsewhere in this application. In some embodiments, such GUI tools are based on display-controlling and input-facilitating software (e.g., on local machine(s) 311, display 319 or smartphone 320).

For example, GUI tools and other user interface aspects, such as any of the graphical “windows,” “buttons,” and data entry fields, may present via, for example, a display, any number of selectable options, actions, commands and/or data entry fields set forth elsewhere in this application. When such options, actions and/or data entry fields are selected or data is entered by a user (e.g., an advertiser user), such selection and/or data entry causes aspects of the control system to command other aspects of the control system to take particular actions and present additional instructions, GUI tools and sub-tools, and/or other guidance to users related to managing business appointments and invitations and managing sales leads or other business projects, as set forth in this application. The processor(s) 307 may execute instructions stored in memory device 503 and/or long-term data storage device 305, and may communicate via system bus(ses) 375. Input/output device 301 is capable of input/output operations for the system, and may include and communicate through input and/or output hardware, and instances thereof, such as a computer mouse, scanning device or other sensors, actuator(s), communications antenna(ae), keyboard(s), smartphone(s) and/or PDA(s), networked or connected additional computer(s), camera(s) or microphone(s), a mixing board(s), real-to-real tape recorder(s), external hard disk recorder(s), additional movie and/or sound editing system(s) or gear, speaker(s), external filter(s), amp(s), preamp(s), equalizer(s), computer display screen(s) or touch screen(s). Such input/output hardware could implement a program or user interface created, in part, by software, permitting the system and user to carry out the user settings and input discussed in this application. Input/output device 301, memory device 303, data storage device 305, and processor(s) 307 are connected and able to send and receive communications, transmissions and instructions via system bus(ses) 375. Data storage device 305 is capable of providing mass storage for the system, and may be or incorporate a computer-readable medium, may be a connected mass storage device (e.g., flash drive or other drive connected to a Universal Serial Bus (USB) port or Wi-Fi), may use back-end (with or without middle-ware) or cloud storage over a network (e.g., the Internet) as either a memory backup for an internal mass storage device or as a primary memory storage means, or may simply be an internal mass storage device, such as a computer hard drive or optical drive. Generally speaking, the system may be implemented as a client/server arrangement, where features of the system are performed on a remote server, networked to the client and made a client and server by software on both the client computer and server computer. In any event, the system may include, or include network connections (e.g., wired, WAN, LAN, 5G, ethernet, satellite, and/or Internet connections) with, any of the example devices or auxiliary devices and/or systems, shown as Internet server(s) 309, local machine(s) 311, cameras and microphones 313, sensor(s) 314, internet of things or other ubiquitous computing devices 315, API 317, scanner 319 and smartphone 320. Similarly, the control system 500 is capable of accepting input from any of those auxiliary devices and systems, and modifying stored data within them and within itself, based on any input or output sent through input/output device 301.

Input and output devices may deliver their input and receive output by any known means, including, but not limited to, any of the hardware and/or software examples shown as internet server(s) 309, local machine(s) 311, cameras and microphones 313, sensor(s) 314, internet of things or other ubiquitous computing devices 315, API 317, display 319 and smartphone 320.

While the illustrated example of a control system 300 in accordance with the present invention may be helpful to understand the implementation of aspects of the invention, any suitable form of computer system known in the art may be used—for example, in some embodiments, a simpler computer system containing just a processor for executing instructions from a memory or transmission source. The aspects or features set forth may be implemented with, and in any combination of, digital electronic circuitry, hardware, software, firmware, middleware or any other computing technology known in the art, any of which may be aided with external data from external hardware and software, optionally, by networked connection, such as by LAN, WAN, satellite communications networks, 5G or other cellular networks, and/or any of the many connections forming the Internet. The system can be embodied in a tangibly-stored computer program, as by a machine-readable medium and propagated signal, for execution by a programmable processor. The many possible method steps of the example embodiments presented herein may be performed by such a programmable processor, executing a program of instructions, operating on input and output, and generating output and stored data. A computer program includes instructions for a computer to carry out a particular activity to bring about a particular result, and may be written in any programming language, including compiled and uncompiled and interpreted languages and machine language, and can be deployed in any form, including a complete program, module, component, subroutine, or other suitable routine for a computer program.

FIG. 4 is a process flow diagram, illustrating some exemplary steps that may be carried out by a control system, or combination of control systems, such as the example control system set forth above, in reference to FIG. 3, comprised in, or comprising, a CRM system, implementing example CRM programming, methodology and other aspects of the present application, in accordance with some embodiments.

Beginning with step 401, the control system may first determine whether the CRM system is loaded and available for use, and connected with input devices and networks required for the CRM system to function. For example, in some embodiments, the CRM system must be connected with one or more local computer systems at a place of business and/or held by agents of the business, and to the Internet and/or a local communications network of the business (such as an automotive business), to properly function. If not, the control system may return to the starting position. If so, however, in some embodiments, the control system proceeds to step 403, in which it attempts to connect with external, additional systems for recording appointments on a calendar (e.g., GOOGLE CALENDAR or OUTLOOK CALENDAR) additional CRM systems and/or platforms (e.g., a CRM system by VINSOLUTIONS). In some embodiments, although a business appointment invitation or reminder is initiated by the control system of the CRM system, as discussed below, it may be generated in such an additional CRM system and/or calendar system, through its own invitation and reminder creation techniques, for example, by communicating a command to create such invitations and reminders (e.g., through a network and/or API connection between the control system and the additional CRM systems, in some such embodiments.

In some embodiments, the control system next proceeds to step 405, in which it determines whether it is receiving communications, for example, through e-mail, text, voice and other communications systems through such APIs, connected CRM systems, or other connected communications systems. If not, the control system returns to step 403.

If the control system is receiving communications, however, the control system proceeds to step 407, in which it scans the text (or, in the instance of voice communications, transcribes and then scans the text) of those communications, and records a separate text file (or other data storage location) for each communication, and labels or otherwise identifies it according to the sender, recipient, date sent, and related communications (e.g., an email to which the communication has replied on a CRM or other networked communications system). For example, in some embodiments, the control system records the text file identifying the date and time that such a message was sent.

The control system may then proceed to step 409, in some embodiments, in which it activates an E-mail Analysis Module of the control system, as such systems are discussed in this application.

The control system may then proceed to step 411, in which, through the E-mail Analysis Module, it analyzes the text of each communication, and, in some embodiments, communications to which the communication relates, with the aid of a business appointment trigger identification algorithm (e.g., as may be generated and refined over time by any of the LLMs discussed in this application). And, in some embodiments, the E-mail Analysis Module then identifies potentially appointment-related key words and phrases within each such text file or other data storage location. Business appointment triggers may be variably defined by a user and/or the system, in various embodiments, and, in some embodiments, the control system generates a business appointment proposal based on particular information determined to be present within the communications. In some embodiments, the business appointment trigger identification algorithm may be provided through direct entry of coefficients and variables by a programmer. However, in some embodiments, an artificial intelligence sub-module, such as a large language model (“LLM”) trained on a wide variety of business correspondence which, in the past, immediately has led to appointment invitations between such an agent of the business of which the control system is an asset, and its customers and leads. In some such embodiments, the LLM is configured to predict, based on the above-described text and sending dates of the above-discussed text file or other data storage location identifying the date and time that such a message was sent, the text and format of one or more appointment invitation(s) that should be sent, and to whom such an appointment should be sent (e.g., to one or both of the agent(s), customer(s) or lead(s)).

Next, the control system may determine, in step 413, whether any business appointment triggers have been identified in the communication(s), after the application of the latest version of the business appointment trigger identification algorithm. If so, the control system proceeds to step 415, in which it applies the latest constraints and settings applicable to business appointment invitation generation, as discussed elsewhere in this application, and, in subsequent step 417, generates any triggered business appointment invitation(s) permitted by the latest constraints and settings (e.g., as variably set by an administrative user, in some embodiments, using a GUI.) In some embodiments, the control system and/or LLM operates under the constraints with respect to the predicted appointment invitation(s) that: 1. a proposed appointment date and time cannot be in the past; 2. a proposed appointment date and time cannot be too far in the future, as may be variably set by an administrative user, in some embodiments, and/or 3. appointments must be made only between conversationally related parties. To generate appointments, in some embodiments, the LLM of the control system initiates a command to an appointment generation sub-module, which may generate one or more appointment invitation(s) to the identified, conversationally-related parties, in some embodiments. In some embodiments, the appointment-generation sub-module does not immediately generate and/or send such an appointment invitation(s) if: 1. the identified, conversationally-related parties have already received a similar appointment invitation; and/or 2. the identified, conversationally-related parties have already accepted a similar appointment invitation. An appointment invitation generated by the appointment-generation sub-module may include a wide variety of appointment-related text, which also may be generated by the algorithm and/or LLM, in some embodiments. For example, in various embodiments, such appointment-related text may include: A. a type of appointment (e.g., describing whether the proposed appointment relates to sales or servicing of a vehicle, in the context of an automotive dealership business using the CRM); B. the name(s) and contact information of the invitees; C. a calendar day proposed for such an appointment; D. a proposed duration of the proposed appointment; E. a proposed start time of the proposed appointment; F. a proposed meeting format (e.g., in-person, via teleconferencing, or video conferencing and if so, a conferencing link or telephone number); G. one or more key expectations or information beneficial for conducting the proposed appointment, such as the make and model of a motor vehicle, where the business in question is an automotive dealership, for example; and H. other agents of the business (such as service staff) that may attend or otherwise be relevant to the appointment.

Following the issuance of any triggered business appointment invitations, the control system next may generate reminders and follow-ups, as discussed elsewhere in this application, in step 419, and updates the statuses and leads, in step 421.

In some embodiments, a follow-up sub-module of the control system is included, which determines whether an appointment subject to such an appointment invitation(s), has taken place (e.g., through a meeting tracking sub-module, or video meeting tracking cookie, in some embodiments). If not, in some such embodiments, the follow-up module re-runs the appointment generation submodule, and generates one or more additional appointment invitation(s) to the identified, conversationally-related parties, and so on, until a threshold number of unsuccessful appointment invitations have been generated for the next appointment between the agent(s), customer(s) or lead(s) subject to the unsuccessful appointment invitations. In some embodiments, the follow-up sub-module generates data related to one or more key performance indicators for a sales agent(s) of the business, or other party subject to the appointment invitation(s), for example, based on the number of unsuccessful appointment invitations generated for one or more meetings.

The control system may then return to the starting position.

In some such embodiments, a user may vary one or more settings, for example, using a specialized graphical user interface (GUI), which settings are related to any of the constraints and thresholds set forth in this application. For example, in some embodiments, an administrative user of the CRM system may variably set a threshold number of unsuccessful appointment invitations to be generated for a next appointment between the agent(s), customer(s) or lead(s) subject to unsuccessful appointment invitations, as that threshold is discussed in this application. As another example, in some embodiments, an administrative user of the CRM system may variably set a number of appointment parameters as constraints, such as the length of time of an appointment proposed in an invitation, or an amount of time into the future from the date of one or more communications between the agent(s), customer(s) or lead(s), that a meeting may be proposed to be held within invitations, as a constraint. In some embodiments, a “calendar view” GUI component is included, which provides a view of all available dates and times for appointments, whether booked or open, for one or more of such business appointment invitees. In some such embodiments, such a calendar view includes multiple open or booked, standardized appointment times—a.k.a., “time blocks.” In some such embodiments, the duration of such time blocks may be variably set (e.g., to 15 or 30-minute intervals), for example, by an administrative user of the CRM system. In some embodiments, multiple different calendar views may be available, for example, to administrative users, to view the open and booked time blocks for different invited parties. For example, in some embodiments such an administrative user is a sales manager, and the multiple different calendar views may each represent a different sales representatives managed by the sales manager. Such a GUI may include lead tracking tools, identifying a list of leads generated by marketing efforts for the business. The GUI may display statuses for each of such leads, based, at least in part, on the status of invitations and appointments, discussed in this application. For example, if a lead has not successfully attended a business appointment subject to such an invitation when scheduled, it may be shown within a “missed” tool and area of the GUI. For example, if a lead has not successfully attended a business appointment subject to such an invitation when scheduled, it may be shown within a “missed leads” tool and area of the GUI. As another example, in some embodiments, if an appointment invitation has not been sent out to a lead, the lead may be shown within an “unappointed leads” tool and area of the GUI. And, as yet another example, if an appointment invitation has been sent out to a lead, and such an invitation has been accepted, the lead may be shown within an “scheduled leads” tool and area of the GUI. In some embodiments, the GUI may include an assignment sub-tool, with respect to a lead indicator tool for each lead, showing an agent of the business assigned to the lead (and the administrative user may reassign such leads to different agents, in some embodiments, using such an assignment sub-tool of the GUI).

In some embodiments, lists of appointments may be received and uploaded, and/or generated by the CRM system, by agent and calendar. For example, in some embodiments, the CRM system may generate a list of business appointments, their status, and other text and information from invitations and notes related to the business appointments, for example, in the form of a .csv or EXCEL file. Conversely, in some embodiments, the CRM system may accept and upload such a list of business appointments, their status, and other text and information from invitations and notes related to the business appointments.

In some embodiments, the CRM system is configured to be integrated with a wide variety of auxiliary or additional communications and calendaring systems. For example, in some embodiments, the CRM system is integrated (e.g., via API or webhook) with a system by VINSOLUTIONS, such as an appointment management system thereof. And, in some embodiments, he CRM system is integrated with commonly-used calendaring software, such as GOOGLE CALENDAR or OUTLOOK CALENDAR. In some such embodiments, information between the CRM system and such an auxiliary or additional communications and calendaring system may be synced (e.g., in real time) via an ongoing, live network and/or API connection(s). In some embodiments, leads identified by the auxiliary or additional communications and calendaring systems may be tracked by the CRM system, and statuses of such leads may be updated within the auxiliary or additional communications and calendaring systems, based on the status of the appointment invitations. For example, where a first appointment invitation has been sent to a sales lead, the sales lead may be labeled “new” through an API interface with VINSOLUTIONS. As another example, where an appointment invitation to a lead has not been accepted or carried out for a threshold amount of time, and the follow-up submodule has been activated, the lead may be labeled as “follow-up” needed. And, as another example, where an appointment has been determined to have taken place, following a business appointment invitation, the lead may be labeled “contacted.” The CRM system may also issue reminders and status updates through such integrations, e.g., at user-variable intervals. For example, missed leads may trigger a missed-lead alert to users, in some embodiments.

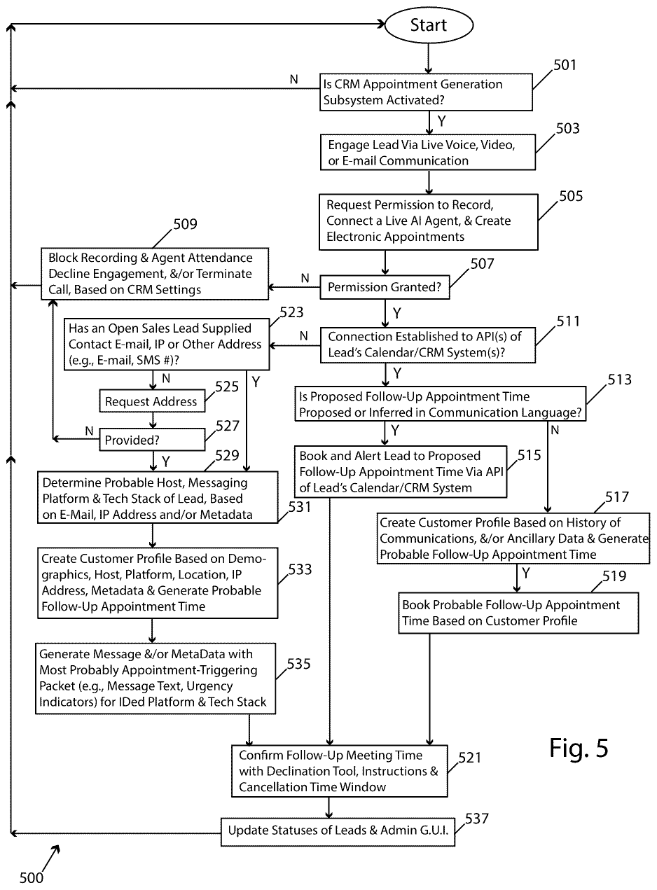

FIG. 5 is also a process flow diagram, illustrating several example steps that may be carried out by a control system, such as the example control system set forth above, in reference to FIG. 3, comprised in, or comprising, an appointment generation subsystem of a CRM system, implementing example appointment booking and invite generation programming, methodology and other aspects of the present application, in accordance with some embodiments.

In some embodiments, the control system begins at step 501, in which it determines whether the appointment generation subsystem of the CRM system is loaded and available for use, and connected with input devices and networks required for the appointment generation subsystem to function. For example, in some embodiments, the appointment generation subsystem must be connected with one or more local computer systems at a place of business and/or held by agents of the business, and to the Internet and/or a local communications network of the business (such as an automotive business), to properly function. And, in some embodiments the appointment generation subsystem must be connected with, and configured to monitor, one or more communications subsystems of a local sales agent of the CRM system, such as a sales agent's email, SMS and/or telephone communications system, which may include telephonic communications hardware, and/or other communications hardware, in some embodiments. If not, in some embodiments, the control system may return to the starting position. Next, in step 503, in some embodiments, the sales agent may proceed to engage a sales lead in a business development communication via such a communications system (e.g., initiating a phone call to the lead, which is routed through computerized telephonic communications hardware of the CRM system, and monitored by the appointment generation subsystem). Generally speaking, in such a business development communication, such a sales agent may introduce themself, and discuss the lead's needs, and the capabilities of the business and/or a product or service of the business, among other business development efforts.

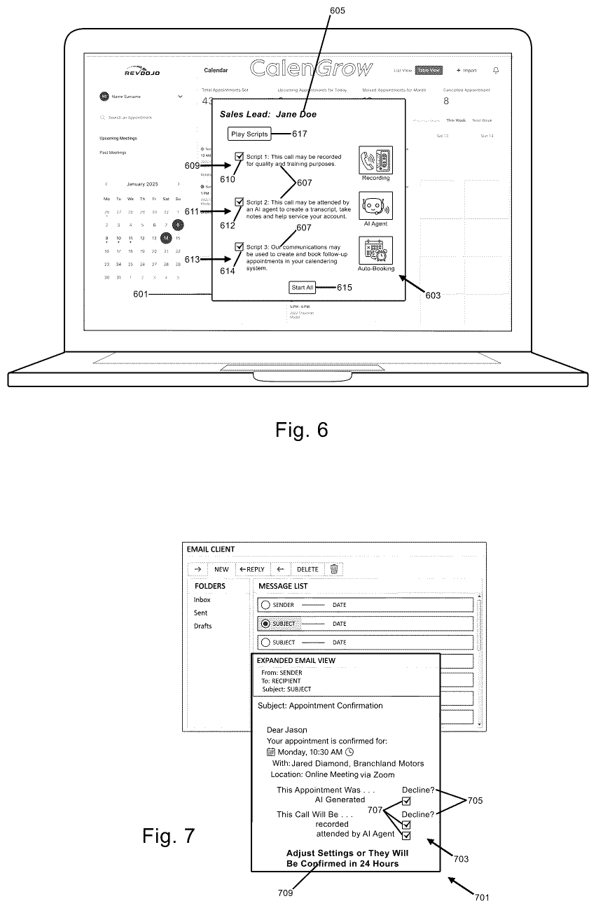

In some embodiments, the control system may next proceed to step 505, in which it provides a specialized GUI, such as the example GUI set forth in reference to FIG. 6, below, prompting the sales agent to disclose that the business development communication will be recorded and request affirmative consent from the lead to such recording. In some embodiments, in the alternative or additionally, such a prompt and disclosure may include a proviso that an AI agent will attend the business development call and/or that an automated appointment generation system may monitor the call and future communications with the sales lead and generate appointment bookings, invites and/or other calendaring steps on a business platform of the sales lead. In any event, in proceeding step 507, the control system may next determine whether such affirmative consent has been obtained. In some embodiments, the control system includes an initial communications monitoring component which analyzes, but does not record, communications being conducted over the communications hardware, and determines whether affirmative consent to recording the sales business development communication (e.g., a telephone call), AI agent attendance or automated appointment generation has been provided by the sales lead—e.g., by analyzing the communication for the presence of affirmative language immediately after a disclosure that the communication will be recorded. In some embodiments, the control system will begin recording the business development communication, connect an AI agent to the business development communication, and/or begin to generate appointment bookings and invites, as the case may be, only if such affirmative consent to each has been obtained. And, in some embodiments, the specialized GUI includes a selectable indicator, or set of indicators, in which the sales agent may indicate when such affirmative consent has been provided, for each such aspect, based on the sales agent's own analysis. In some such embodiments, the control system may refrain from initial monitoring of the business development communication, relying instead on the sales agent's analysis and selection of indicators, as discussed immediately above. In any event, if such consent is not determined to have been provided, in some embodiments, the control system will prevent any recording and/or further communications by the sales agent through communications hardware (e.g., with a communications cutoff switch) in subsequent step 509. In some embodiments, the control system may play an automated recording, indicating that any business engagement has been terminated, due to the lack of consent to recording, AI agent attendance and/or automated appointment generation, as the case may be.

Next, the control system may proceed to step 511, in some embodiments, in which it determines whether the CRM system and/or the appointment generation subsystem has been connected to a business and/or communications platform of the sales lead via an API and/or webhook. If so, the control system may proceed to step 513, in which it begins to analyze communications between the sales agent and lead—e.g., through an e-mail or other Communications Analysis Module, such as any of those discussed in this application. As discussed elsewhere in this application, in some embodiments, such a Communications Analysis Module analyzes the text of each communication (e.g., e-mail correspondence) between the sales agent and lead through the connected communications platform, with the aid of a business appointment trigger identification algorithm (e.g., as may be generated and refined over time by any of the LLMs discussed in this application). And, in some embodiments, the Communication Analysis Module then identifies potentially appointment-related key words and phrases within text in those communications. For example, in some embodiments, the Communication Analysis Module may determine that language within the communications indicates that an appointment may be held at a particular time and through a particular method, in the future, which may serve as a trigger for the CRM system to create a booking or invitation. As also discussed elsewhere in this application, business appointment triggers may be variably defined by a user and/or the control system, in various embodiments. In any event, the control system generates a business appointment invite or business appointment booking in response to determining that those triggers are present within the communications, in some such embodiments. If the control system determines whether any business appointment triggers have been identified in the communication(s), after the application of the latest version of the business appointment trigger identification algorithm, the control system proceeds to step 515, in which it may issue an invite and/or book an appointment on the customer's business management platform, via the API or webhook. In some such embodiments, the CRM system may also issue an alert to the customer that the invite or booking has been created.

In some embodiments, however, even though full access to communications between the sales agent and the lead has been granted via such an API and/or webhook, the language within the communications may not indicate a specific appointment time, or proposed appointment time, and meeting platform, among other appointment-indicating language. In that instance, the control system may proceed to step 517, in which it creates a profile for the lead (a.k.a., a “customer profile”) based on the full history of the communications between the sales agent and lead, among other, ancillary data for creating such profiles, which will be discussed in greater detail below, such as the lead's communications address(es) (e.g., email address, IP address, SMS number, etc.), host, business or communications platform and/or geolocation. Generally speaking, a customer profile may include user behavior and habitual information, as well preferred work schedule times, and the control system may use the customer profile information in subsequent step 519, to determine a time, among a discrete set of options, that is most probably ideal for the lead for holding a follow-up appointment, and may issue an invite and/or book an appointment on the customer's business management platform, via the API or webhook. In some such embodiments, the CRM system may also issue an alert to the customer that the invite or booking has been created.

Subsequently, the control system may proceed to step 521, in which it issues an appointment confirmation to the lead—e.g., through the appointment generation subsystem thereof. Such an appointment confirmation may include a GUI including a booking and/or invite declination tool, allowing the lead to quickly and easily decline the booked appointment and/or invite. In some embodiments, the appointment confirmation GUI may include instructions for declining the booking or invitation, and express a time window for declining it, after which the booking or invite will be considered confirmed if the declination tool is not used. Examples of a GUI including such a declination tool are discussed in further detail below, in reference to FIG. 7.

Returning to Step 511, if the control system determines that the CRM system and/or the appointment generation subsystem has actually not been connected to a business and/or communications platform of the sales lead via an API and/or webhook to the lead's business and/or communications platform, the control system may instead proceed to Steps 523 et seq., in which it begins to take additional steps to help build a customer profile, such as that discussed above, but without the benefit of the API or webhook. For example, in Step 523, the control system may first determine and analyze whether the lead has supplied the CRM system and/or the sales agent with a communications address, such as an e-mail address or SMS number, or an IP address, geolocation, or other metadata that may be useful in building a customer profile for the lead. If not, the control system may proceed to Step 525, in which it requests the lead to provide such a communications address, or addresses. In Step 527, the control system determines whether the lead has provided such a communications address, or addresses and, if not, in some embodiments, the control system proceeds to Step 509 and, as discussed above in that step, the control system may prevent any recording and/or further communications by the sales agent with the lead through communications hardware (e.g., with a communications cutoff switch), and, in some such embodiments, may play an automated recording indicating that any business engagement between the sales agent and/or business, on the one hand, and the lead, on the other hand, has been terminated, due to the lack of consent to the businesses contractual terms, if they include the provision of such communications addresses, as may be variably indicated by the business and/or a user of the CRM system (e.g., via settings).

However, if the lead has provided such a communications address, in Step 523, in some embodiments, the control system then proceeds directly to Step 529, in some embodiments, in which it determines, based at least in part on the communications addresses provided, an actual, or probable, business or communications platform, geolocation, web host, or other technologies being used by the lead to interact with the sales agent and otherwise conduct business (the lead's “TechStack”). In some embodiments, the control system then proceeds to Step 531, in which it builds a customer profile, such as that discussed above, without the benefit of the API or webhook. In some embodiments, such a customer profile includes

As discussed above, such a customer profile may include user behavior and habitual information, as well preferred work schedule times, and the control system may use the customer profile information to determine a time that is most probably ideal for the lead for holding a follow-up appointment.

Rather than use an API, webhook, or other protocol to book an appointment or send an invite for an appointment via the lead's communications and/or business platform, however, in Step 533, the control system may instead generate an appointment-triggering packet, which may include a message and/or metadata sent to the lead which is determined to most likely create a booked appointment, invite or reminder for the lead on some aspect of the lead's TechStack. In some such embodiments, the CRM system may also issue an alert to the customer that the invite or booking has been created, and may also issue an appointment confirmation to the lead—e.g., through the appointment generation subsystem thereof. As mentioned above, such an appointment confirmation may include a GUI including a booking and/or invite declination tool, allowing the lead to quickly and easily decline the booked appointment and/or invite.

Following the issuance of the triggered business appointment invitations and invites (without the use of the API), the control system next may generate updates to statuses and leads within the CRM system, for further actions, in Step 537.

In some embodiments, the CRM system may be known as CALENGROW.

FIG. 6 depicts an additional example GUI 601 including some additional example GUI tools 603, which also may be utilized by a sales agent user of a CRM system, in accordance with some embodiments of the present application.

As mentioned above, in some embodiments, a sales agent may engage a sales lead in a business development communication via such a communications system (e.g., initiating a phone call to the lead, which is routed through computerized telephonic communications hardware of the CRM system, and monitored by the appointment generation subsystem). Generally speaking, in such a business development communication, such a sales agent may introduce themself, and discuss the lead's needs, and the capabilities of the business and/or a product or service of the business, among other business development efforts. To aid in servicing the sales lead, GUI 601 may include a sales lead identifier such as that shown as example sales lead identifier 605, identifying the sales lead being serviced by name, in some embodiments.

And, as also mentioned above, in some embodiments, the control system may provide specialized GUI tools, such as the example GUI tools 607, prompting the sales agent to make certain important disclosures to the sales lead, prior to continuing communication with the sales lead. For example, call recording consent GUI tool 609 prompts the sales agent user to read a script to the sales lead, and request and obtain affirmative consent, to the effect that the sales lead consents to having all communications with the sales lead agent recorded (e.g., via audio and/or transcript, e.g., through a speech-to-text aspect of the CRM system). In some embodiments, if such consent has been obtained, a variable consent indicator 610 may be checked off or otherwise activated, or deactivated, to create a record that such affirmative consent has been obtained, or retracted, respectively from the sales lead.

In some embodiments, a plurality of variable consent indicators and a sub-tool causing a plurality of selected scripts to be played by the first control system, prior to the first control system enabling the selection of any of the variable consent indicators.

As another example, in some embodiments, an AI Agent attendance consent GUI tool 611 prompts the sales agent user to read a script to the sales lead, and request and obtain affirmative consent, to the effect that the sales lead consents to having an AI agent attend all communications between the sales agent and the sales lead. In some embodiments, if such consent has been obtained, a variable consent indicator 612 may be checked off or otherwise activated, or deactivated, to create a record that such affirmative consent has been obtained, or retracted, respectively from the sales lead.

As another example, in some embodiments, an appointment generation consent GUI tool 613 prompts the sales agent user to read a script to the sales lead, and request and obtain affirmative consent, to the effect that the CRM will generate appointment bookings and/or invites, based on any and all communications between the sales lead and the sales agent. In some embodiments, if such consent has been obtained, a variable consent indicator 614 may be checked off or otherwise activated, or deactivated, to create a record that such affirmative consent has been obtained, or retracted, respectively from the sales lead.

And, if the sales lead has indicated consent to each of the above activities by the CRM system, in some embodiments, the CRM system will proceed to generate appointment bookings, invites and/or other calendaring steps on a business platform of the sales lead, as discussed in greater detail elsewhere in this application. In some embodiments, the CRM system may itself determine whether such affirmative consent has been obtained, rather than rely on the sales agent to activate consent indicators, as discussed above and shown in the present figure. Also as discussed above, in some embodiments, the control system includes an initial communications monitoring component which analyzes, but does not record, communications being conducted over the communications hardware, and determines whether affirmative consent to recording the sales business development communication (e.g., a telephone call), AI agent attendance or automated appointment generation has been provided by the sales lead—e.g., by analyzing the communication for the presence of affirmative language immediately after a disclosure that the communication will be recorded. In some embodiments, the control system will begin recording the business development communication, connect an AI agent to the business development communication, and/or begin to generate appointment bookings and invites, as the case may be, only if such affirmative consent to each has been obtained.

In some such embodiments, the control system may refrain from initial monitoring of the business development communication, relying instead on the sales agent's analysis and selection of indicators, as discussed immediately above. In any event, if such consent is not determined to have been provided, in some embodiments, the control system will prevent any recording and/or further communications by the sales agent through communications hardware (e.g., with a communications cutoff switch). But, if consent has been obtained to each activity, in some embodiments, the sales agent is prompted to confirm and cause the CRM system to begin each such activity, with a consent and activity confirmation GUI tool 615. In some embodiments, rather than have the sales agent read each proviso, the control system may play an automated recording (e.g., if the sales agent selects an automated proviso playback tool 617), indicating that any business engagement has been terminated, due to the lack of consent to recording, AI agent attendance and/or automated appointment generation, as the case may be.

FIG. 7 depicts an additional example appointment booking confirmation GUI 701 including some additional example GUI tools 703, which may be issued to and utilized by a sales lead user of a CRM system as an appointment booking confirmation, in accordance with some embodiments of the present application.

As discussed above, in some embodiments, a CRM system issues an appointment booking confirmation to such a sales lead—e.g., through the appointment generation subsystem thereof. Such an appointment booking confirmation may be included within booking confirmation GUI 701, and may include one or more booking and/or invite declination tool(s) 705, included within GUI tools 703. In some embodiments, booking and/or invite declination tool 705 aids the sales lead in decline consent to one or more activities to be undertaken by the CRM system at the time of the appointment, and in generating the appointment booking and/or invite—e.g., by selecting or deselecting one or more consent indicators 707. In some embodiments, the appointment confirmation GUI includes instructions 709 for declining the booking or invitation, and may express a time window 711, for declining any of them, after which the booking or invite will be considered confirmed if the declination tool is not used.

The embodiments set forth in detail in this application are to ease the reader's understanding of inventions set forth herein and, as such, are only examples of the virtually innumerable number of alternative embodiments falling within the scope of the application. No specific embodiment set forth in this application should be read as limiting the scope of any claimed inventions.

1. A system for managing appointments, comprising:
a customer relationship management system (CRM) comprising a first control system, comprising one or more processor(s) and software, verifying an identity of an administrative user based on multi-factor authentication, and providing access to at least one graphical user interface (GUI) to the administrative user;
a display, communicatively connected with and controlled by said first control system, comprising at least one of said at least one GUI;
an appointment generation subsystem, configured to trigger the generation of an invitation and a booked appointment via an appointment-triggering communications packet communicated over an e-mail, SMS or another form of electronic message, comprising appointment-booking coded commands which are immediately scanned and executed by a receiving peripheral device of a second user containing an additional control system comprising an additional one or more processor(s) and software;
wherein the contents and structure of such an appointment-triggering communications packet and the coded commands are based on a customer profile of said second user determined by a customer profile assessment artificial intelligence subsystem of the CRM system.

2. The system for managing appointments of claim 1, wherein the appointment generation subsystem comprises:
a communications subsystem, configured to generate and said e-mail, SMS or another form of electronic message.

3. The system for managing appointments of claim 1, wherein the appointment generation subsystem comprises:
a first calendaring system, capable of maintaining appointments for said administrative user.

4. The system for managing appointments of claim 3, wherein the first calendaring system comprises communicative connections with a second calendaring system of said receiving peripheral device of a second user.

5. The system for managing appointments of claim 4, wherein the first calendaring system's communicative connections with a second calendaring system of said receiving peripheral device of a second user comprise an Application Programming Interface (API).

6. The system for managing appointments of claim 4, wherein the first calendaring system's communicative connections with a second calendaring system of said receiving peripheral device of a second user comprise a webhook.

7. The system for managing appointments of claim 4, wherein the first control system verifies an identity of a third, sales agent user of the system based on multi-factor authentication, and provides access to at least one additional GUI to the third, sales agent user.

8. The system for managing appointments of claim 7, wherein the at least one additional GUI comprises a plurality of variable consent indicators and a sub-tool causing a plurality of selected scripts to be played by the first control system, prior to the first control system enabling the selection of any of the variable consent indicators.

9. The system for managing appointments of claim 8, wherein the control system prevents recording a communication by said control system with said second user, through said peripheral device, if one or more of the variable consent indicators have not been activated.

10. The system for managing appointments of claim 8, wherein the control system prevents recording a communication by said control system with said second user, through said peripheral device, if all of the one or more variable consent indicators have not been activated.

11. The system for managing appointments of claim 9, wherein the control system plays an automated recording indicating that any business engagement has been terminated due to the lack of consent to recording, AI agent attendance and/or automated appointment generation.

12. The system for managing appointments of claim 10, wherein the control system plays an automated recording indicating that any business engagement has been terminated due to the lack of consent to recording, AI agent attendance and/or automated appointment generation.

13. The system for managing appointments of claim 8, wherein the control system permits recording a communication by said control system with said second user, through said peripheral device, if one or more of the variable consent indicators have been activated.

14. The system for managing appointments of claim 8, wherein the control system comprises an artificial intelligence sub-system, and wherein said artificial intelligence sub-system generates a dedicated AI agent, based on an LLM trained on said second user's customer profile, to monitor and/or conduct communications with said second user through the peripheral device, if one or more of the variable consent indicators have been activated.

15. The system for managing appointments of claim 1, wherein the peripheral device of a second user generates an invite declination tool(s), and, if the invite declination tool(s) is not actuated by the second user, the control system enables and records a subsequent communication by said control system with said second user, or prohibits and does not record the subsequent communication if the invite declination tool is actuated by the second user.

16. The system for managing appointments of claim 1, wherein the peripheral device of a second user generates an invite declination tool(s), and, if the invite declination tool(s) is not actuated by the second user, the control system enables and causes a subsequent communication by said control system with said second user to be attended by an AI agent, or does not enable and prevents the subsequent communication if the invite declination tool is actuated by the second user.

17. A method for managing appointments, comprising the following steps:
providing a system for managing appointments, comprising:
a customer relationship management system (CRM) comprising a first control system, comprising one or more processor(s) and software, verifying an identity of an administrative user based on multi-factor authentication, and providing access to at least one graphical user interface (GUI) to the administrative user;
a display, communicatively connected with and controlled by said first control system, comprising at least one of said at least one GUI;
an appointment generation subsystem, configured to trigger the generation of an invitation and a booked appointment via an appointment-triggering communications packet communicated over an e-mail, SMS or another form of electronic message, comprising appointment-booking coded commands which are immediately scanned and executed by a receiving peripheral device of a second user containing an additional control system comprising an additional one or more processor(s) and software;
wherein the contents and structure of such an appointment-triggering communications packet and the coded commands are based on a customer profile of said second user determined by a customer profile assessment artificial intelligence subsystem of the CRM system.
